(19) United States
(12) Patent Application Publication
(10) Pub. No.: US 2020/0320328 A1
(43) Pub. Date: Oct. 8, 2020

(54) IMAGE PROCESSING DEVICE, CONTROL METHOD, AND CONTROL PROGRAM

(71) Applicant: PFU LIMITED, Kahoku-shi, Ishikawa (JP)

(72) Inventors: Yuki KASAHARA, Kahoku-shi (JP); Masato IZUMI, Kahoku-shi (JP)

(21) Appl. No.: 16/755,118

(22) PCT Filed: Nov. 17, 2017
(86) PCT No.: PCT/JP2017/041541

§ 371 Date: Apr. 9, 2020

(51) Int. Cl. G06K 9/34; G06K 9/03; G06K 9/32

(52) U.S. Cl. CPC G06K 9/344; G06K 2209/01; G06K 9/3233; G06K 9/036

(57) ABSTRACT

Provided are an image processing apparatus, a control method, and a control program for further shortening the time required for recognition processing. An image processing apparatus includes, an operation module, a display module, an imaging module to successively generate an input image, an evaluation point calculation module to calculate, for each of the successively generated input images, an evaluation point for each of a plurality of character candidates for a character in each input image, and a character recognition module to recognize, when a character candidate whose degree of certainty based on the plurality of evaluation points calculated for each of the successively generated input images is equal to or greater than a threshold value is present, the character candidate as a character in the input image. The character recognition module terminates processing of calculating the evaluation point, even when a character candidate having the degree of certainty equal to or greater than the threshold value is not present, in a case where a predetermined condition is satisfied since processing of calculating the evaluation point starts, displays, on the display module, the plurality of character candidates in order based on the evaluation point, and sets, when one of character candidates displayed on the display module is designated by a user with the operation module, the designated character candidate as a character in the input image.

### FIELD

The present disclosure relates to an image processing apparatus, a control method, and a control program, and particularly relates to an image processing device, a control method, and a control program that recognize a character in an input image.

### BACKGROUND

In a facility inspection operation carried out at a factory, a house, etc., an operator reads a numerical value indicating a power amount, etc., from a meter (device) indicating the power amount, etc., through visual inspection, and records the numerical value on an inspection book being a paper ledger. However, in such a manual operation, an incorrect numerical value may be recorded on the inspection book due to a human error, and the operator may need to re-perform the facility inspection operation, In order to avoid such a problem, a technique for automatically recognizing a character such as a numerical value by a computer from an image in which a meter is captured with a camera has been used in facility inspection operations in recent years.

A computer that displays a read character string being read from an image captured with a camera is disclosed (see PTL 1). This computer receives an operation on a display range of a read character string, determines a character to be corrected in the read character string, and displays a candidate character derived for the character to be corrected. This computer receives an operation of approving a displayed candidate character, and replaces the character to be corrected in the read character string with the approved candidate character.

An optical character reading device that displays a recognized result as a character string on a display is disclosed (see PTL 2). When displaying a recognized result, this optical character reading device displays, as a recognition result, all candidate characters instead of only a first candidate character for a character that is highly likely to be mistakenly recognized, and displays the recognition result while switching each character in a character string.

### CITATION LIST

### Patent Literature

[PTL 1] Japanese Unexamined Patent Application Publication (Kokai) No. 2014-178954

[PTL 2] Japanese Unexamined Patent Application Publication (Kokai) No. H05-217017

### SUMMARY

It is desired that time required for recognition processing is further shortened in an image processing apparatus that recognizes a character in an input image.

An object of an image processing apparatus, a control method, and a control program is to further shorten the time required for recognition processing.

According to some embodiments, an image processing apparatus includes, an operation module, a display module, an imaging module to successively generate an input image, an evaluation point calculation module to calculate, for each of the successively generated input images, an evaluation point for each of a plurality of character candidates for a character in each input image, and a character recognition module to recognize, when a character candidate whose degree of certainty based on the plurality of evaluation points calculated for each of the successively generated input images is equal to or greater than a threshold value is present, the character candidate as a character in the input image. The character recognition module terminates processing of calculating the evaluation point, even when a character candidate having the degree of certainty equal to or greater than the threshold value is not present, in a case where a predetermined condition is satisfied since processing of calculating the evaluation point starts, displays, on the display module, the plurality of character candidates in order based on the evaluation point, and sets, when one of character candidates displayed on the display module is designated by a user with the operation module, the designated character candidate as a character in the input image.

According to some embodiments, a control method of an image processing apparatus including an operation module, a display module, an imaging module to successively generate an input image, includes calculating, for each of the successively generated input images, an evaluation point for each of a plurality of character candidates for a character in each input image, and recognizing, when a character candidate whose degree of certainty based on the plurality of evaluation points calculated for each of the successively generated input images is equal to or greater than a threshold value is present, the character candidate as a character in the input image. In the recognizing step, processing of calculating the evaluation point is terminated, even when a character candidate having the degree of certainty equal to or greater than the threshold value is not present, in a case where a predetermined condition is satisfied since processing of calculating the evaluation point starts, the plurality of character candidates is displayed on the display module, in order based on the evaluation point, and when one of character candidates displayed on the display module is designated by a user with the operation module, the designated character candidate is set as a character in the input image.

According to some embodiments, a control program of an image processing apparatus including an operation module, a display module, an imaging module to successively generate an input image, causes the image processing apparatus to execute calculating, for each of the successively generated input images, an evaluation point for each of a plurality of character candidates for a character in each input image, and recognizing, when a character candidate whose degree of certainty based on the plurality of evaluation points calculated for each of the successively generated input images is equal to or greater than a threshold value is present, the character candidate as a character in the input image. In the recognizing step, processing of calculating the evaluation point is terminated, even when a character candidate having the degree of certainty equal to or greater than the threshold value is not present, in a case where a predetermined condition is satisfied since processing of calculating the evaluation point starts, the plurality of character candidates is displayed on the display module, in order based on the evaluation point, and when one of character candidates displayed on the display module is designated by a user with the operation module, the designated character candidate is set as a character in the input image.

According to the present embodiment, the image processing apparatus, the control method, and the control program are able to further shorten the time required for recognition processing.

The object and advantages of the invention will be realized and attained by means of the elements and combinations, in particular, described in the claims. It is to be understood that both the foregoing general description and the following detailed description are exemplary and explanatory, and are not restrictive of the invention, as claimed.

### BRIEF DESCRIPTION OF DRAWINGS

FIG. 1 is a diagram illustrating one example of a schematic configuration of an image processing apparatus 100 according to an embodiment.

FIG. 2 is a diagram illustrating a schematic configurationof a storage device 110 and a CPU 120.

FIG. 3 is a flowchart illustrating an example of an operation of whole processing.

FIG. 4 is a flowchart illustrating an example of an operation of determination processing.

FIG. 5 is a diagram illustrating one example of an input image 500.

FIG. 6A is a diagram illustrating one example of a data structure of a character region table.

FIG. 6B is a diagram illustrating one example of a data structure of a character candidate table.

FIG. 7 is a flowchart illustrating an example of an operation of display processing.

FIG. 8A is a diagram illustrating one example of a display screen 800.

FIG. 8B is a diagram illustrating one example of a display screen 820 in which a character candidate is switched.

FIG. 9 is a diagram illustrating a schematic configuration of another processing circuit 230.

### DESCRIPTION OF EMBODIMENTS

Hereinafter, an image processing apparatus according to an embodiment, will be described with reference to the drawings. However, it should be noted that the technical scope of the invention is not limited to these embodiments, and extends to the inventions described in the claims and their equivalents.

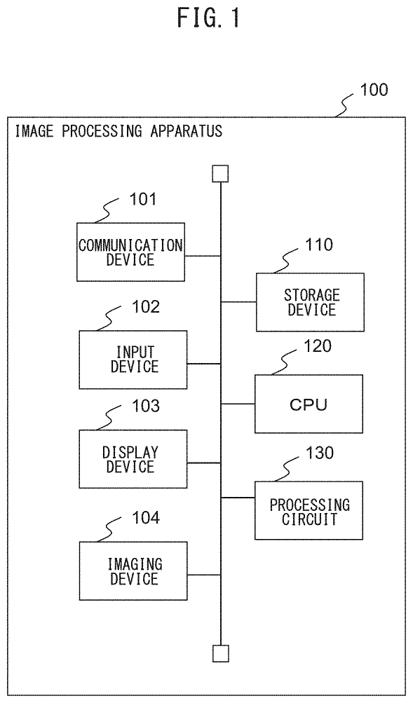

FIG. 1 is a diagram illustrating one example of a schematic configuration of an image processing apparatus 100 according to an embodiment.

The image processing apparatus 100 is a portable information processing device such as a tablet PC, a multifunctional cellular phone (so-called smartphone), a personal digital assistant, and a notebook PC, and is used by an operator being a user thereof. The image processing apparatus 100 includes a communication device 101, an input device 102, a display device 103, an imaging device 104, a storage device 110, a central processing unit (CPU) 120, and a processing circuit 130. Hereinafter, details of each of the modules of the image processing apparatus 100 will be described.

The communication device 101 includes a communication interface circuit including an antenna having a susceptible band such as mainly 2.4 GHz band and 5 GHz. The communication device 101 performs wireless communication with an access point, etc., based on a wireless communication method of The Institute of Electrical and Electronics Engineers, Inc. (IEEE) 802.11 standard. Then, the communication device 101 performs transmission and reception of data with an external server device (not illustrated) via the access point. The communication device 101 supplies data received from the server device via the access point to the CPU 120, and transmits data supplied from the CPU 120 to the server device via the access point. Note that the communication device 101 may be any device as long as the device can communicate with an external device. For example, the communication device 101 may be a device that communicates with the server device via a non-illustrated base station device according to a cellular phone communication method, and may be a device that communicates with the server device according to a wired LAN communication method.

The input device 102 is one example of an operation module, and includes an input device, such as a touch panel input device, a keyboard, and a mouse, and an interface circuit that acquires a signal from the input device. The input device 102 receives a user input, and outputs a signal depending on the user input to the CPU 120.

The display device 103 is one example of a display module, and includes a display constituted of a liquid crystal, an organic electro-luminescence (EL), etc., and an interface circuit that outputs image data or various types of information to the display. The display device 103 is connected to the CPU 120, and displays image data output from the CPU 120 on the display. Note that the input device 102 and the display device 103 may be integrally constituted by using a touch panel display.

The imaging device 104 includes an image capturing sensor of a reduction optical system type including an image capturing element constituted of charge coupled devices (CCDs) arranged one-dimensionally or two-dimensionally, and an A/D converter. The imaging device 104 is one example of an imaging module, and successively captures a meter, etc., according to an instruction from the CPU 120 and successively generates an input image (for example, 30 frames/sec). The image capturing sensor generates a captured analog image signal,and outputs the analog image signal to the A/D converter. The A/D converter converts the output analog image signal from analog to digital, successively generates digital image data, and outputs the digital image data to the CPU 120. Note that a contact image sensor (CIS) of an unmagnification optical system type including an image capturing element constituted of a complementary metal oxide semiconductor (CMOS) instead of the CCD may be used. Hereinafter, digital image data being captured and output by the imaging device 104 may be referred to as an input image.

The storage device 110 is one example of a storage module. The storage device 110 includes memory devices such as a RAM (Random Access Memory), a ROM (Read Only Memory), etc., a fixed disk device such as a hard disk, or a portable storage device such as a flexible disk, an optical disk, etc. The storage device 110 stores computer programs, databases, tables, etc., used for various kinds of processing of the image processing apparatus 100. The computer program may be installed on the storage device 301 from a computer-readable, non-transitory medium such as a compact disk read only memory (CD-ROM), a digital versatile disk read only memory (DVD-ROM), or the like by using a well-known setup program etc. Further, a character region table that manages a character region detected from each input image, a character candidate table that manages a character candidate detected in each character region, etc., are stored in the storage device 110. Details of each of the tables will be described later.

The CPU 120 operates according to a program stored in advance in the first storage device 110. CPU 120 may be a general purpose processor. Note that a digital signal processor (DSP), a large scale integration (LSI), etc., may be used instead of the first CPU 120. Alternatively, an Application Specific Integrated Circuit (ASIC), a field-programming gate array (FPGA) etc., may be used instead of the first CPU 120.

The CPU 120 is connected to the communication device 101, the input device 102, the display device 103, the imaging device 104, the storage device 110, and the processing circuit 130, and controls each of the modules. The CPU 120 performs data transmission/reception control via the communication device 101, input control of the input device 102, display control of the display device 103, image capturing control of the imaging device 104, control of the storage device 110, etc. The CPU 120 recognizes a character captured (included) in an input image generated by the imaging device 104, and also displays a character candidate on the display device 103. When the displayed character candidate is designated by a user with the input device 102, the CPU 12.0 sets the designated character candidate as a character in the input image.

The processing circuit 130 performs predetermined image processing such as correction processing on an input image acquired from the imaging device 104. Note that an LSI, a DSP, an ASIC, an FPGA, etc., may be used as the processing circuit 130.

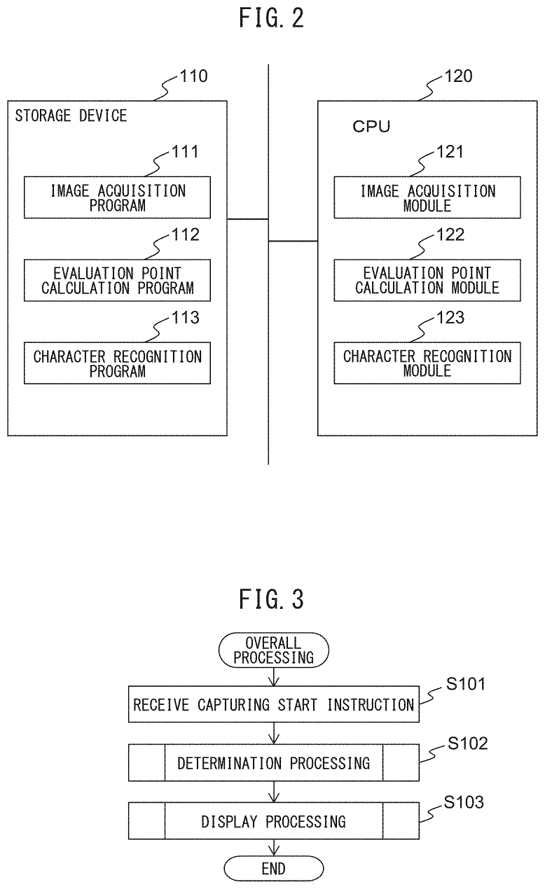

FIG. 2 is a diagram illustrating a schematic configuration of the storage device 110 and. the CPU 120.

As illustrated in FIG. 2, each program such as an image acquisition program 111, an evaluation point calculation program 112, and a character recognition program 113 is stored in the storage device 110. Each of the programs is a functional module mounted by software operating on a processor. The CPU 120 reads each of the programs stored in the storage device 110 and operates according to each of the read programs, and thus functions as an image acquisition module 121, an evaluation point calculation module 122, and a character recognition module 123,

FIG. 3 is a flowchart illustrating an example of an operation of overallprocessing by the image processing apparatus 100.

Hereinafter, the example of the operation of the overall processing by the image processing apparatus 100 will be described while referring to the flowchart illustrated in FIG. 3. Note that a flow of the operation described below is performed in cooperation with each element of the image processing apparatus 100 mainly by the CPU 120, based on the program being previously stored in the storage device 110.

First, when a capturing start instruction that instructs a start of capturing by a user with the input device 102 is input to the image acquisition module 121 and the image acquisition module 121 receives a capturing start instruction signal from the input device 102, the image acquisition module 121 receives the capturing start instruction (step S101). When receiving the capturing start instruction, the image acquisition module 121 performs initialization of each piece of information used for image processing and parameter setting such as an image capturing size and a focus of the imaging device 104, and causes the imaging device 104 to capture a character, etc., and generate an input image. The image acquisition module 121 successively stores, in the storage device 110, the input image being successively generated by the imaging device 104.

Next, the evaluation point calculation module 122 and the character recognition module 123 perform determination processing (step S102). In the determination processing, the evaluation point calculation module 122 detects a character candidate from the input image generated by the imaging device 104, and calculates an evaluation point for each character candidate. Further, when a character candidate having a degree of certainty based on an evaluation point equal to or greater than a predetermined threshold value is present, the character recognition module 123 recognizes the character candidate as a character in the input image. When a predetermined condition is satisfied since processing of calculating an evaluation point starts, the character recognition module 123 terminates the processing of calculating an evaluation point even when a character candidate having a degree of certainty equal to or greater than the predetermined threshold value is not present. Details of the determination processing will be described later.

Next, the character recognition module 123 performs display processing (step S103), and terminates a series of the steps. In the display processing, the character recognition module 123 displays, on the display device 103, each character candidate in order based on the evaluation points. When the character candidate displayed on the display device 103 is designated by the user with the input device 102, the character recognition module 123 sets the designated character candidate as a character in the input image. Details of the display processing will be described later.

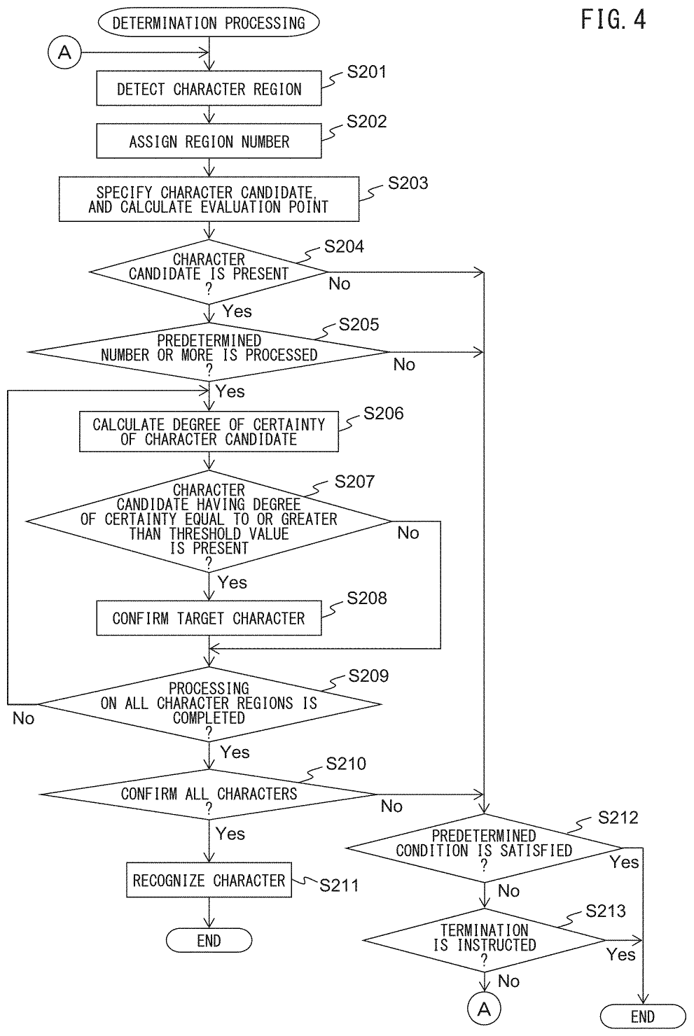

FIG. 4 is a flowchart illustrating an example of an operation of the determination processing. A flow of the operation illustrated in FIG. 4 is performed in step S102 in the flowchart illustrated in FIG. 3. Each processing in steps S201 to S213 in FIG. 4 is performed on each input image being successively generated by the imaging device 104.

First, the evaluation point calculation module 122 detects a character region in which a character is captured from an input image (step S201).

When the image in which the character is captured is input, the evaluation point calculation module 122 detects a partial region by a discriminator being previously learned in such a way as to output positional information about each character region including each character in an image. This discriminator is previously learned by using a plurality of images in which a character is captured, by deep learning, etc., for example, and is previously stored in the storage device 110. The evaluation point calculation module 122. inputs the input image to the discriminator, and detects a character region by acquiring positional information output from the discriminator.

Alternatively, when an absolute value of a difference in brightness value or color value (R value, B value, G value) between pixels on both sides in horizontal and vertical directions of a. pixel in the input image or between a plurality of pixels located away at a predetermined distance from the pixel exceeds a threshold value, the evaluation point calculation module 122 extracts the pixel as an edge pixel. The evaluation point calculation module 122 determines whether or not each extracted edge pixel couples to another edge pixel, and labels the coupled edge pixels as one group. The evaluation point calculation module 122 detects, as a character region, an outer edge (or a circumscribed rectangle) of a region surrounded by a group having the greatest area among extracted groups. Alternatively, the evaluation point calculation module 122 detects a character from the input image by using a known optical character recognition (OCR) technique, and, when the character can be detected, the evaluation point calculation module 122 may detect a region thereof as a character region.

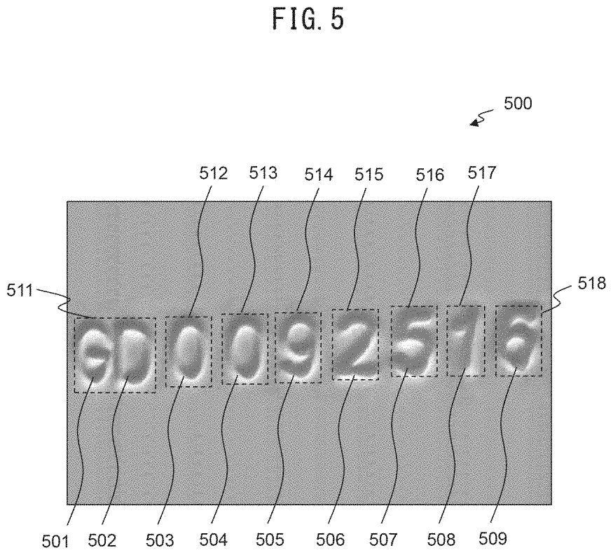

FIG. 5 is a diagram illustrating one example of an input image 500.

As illustrated in FIG. 5, a plurality of characters 501 to 509 are captured in this input image 500. Note that a character captured in an input image may include a number (503 to 509), a symbol (not illustrated), etc. Character regions 511 to 518 surrounding the respective characters 501 to 509 are detected from this input image 500. Note that, as illustrated in FIG, 5, the plurality of characters 501 and 502 may be included in one character region 511. Each character region is one example of a group of a character in an input image.

Note that, when a meter in which a character (number) region is surrounded by a plate frame, etc., are captured, the evaluation point calculation module 122 may detect the plate frame from an input image, and detect the region surrounded by the plate frame as a character region. In this case, the evaluation point calculation module 122 extracts a straight line passing through the vicinity of each extracted edge pixel by using Hough transform, a least squares method, etc., and detects, as a plate frame, the largest rectangle among rectangles constituted of four straight lines in which two lines of the extracted straight lines are substantially orthogonal to the other two lines.

Alternatively, the evaluation point calculation module 122 may detect a plate frame by using a difference between a color of a housing of a meter and a color of a plate. When a brightness value or a color value of each pixel is less than a threshold value (, which indicates black), and a brightness value or a color value of a pixel adjacent on the right side to the pixel or a pixel located away at a predetermined distance from the pixel toward the right side is equal to or greater than the threshold value (, which indicates white), the evaluation point calculation module 122 extracts the pixel as a left end edge pixel. This threshold value is set to a value between a value indicating black and a value indicating white. Similarly, when a brightness value or a color value of each pixel is less than the threshold value, and a brightness value or a color value of a pixel adjacent on the left side to the pixel or a pixel located away at a predetermined distance from the pixel toward the left side is equal to or greater than the threshold value, the evaluation point calculation module 122 extracts the pixel as a right end edge pixel. Similarly, when a brightness value or a color value of each pixel is less than the threshold value, and a brightness value or a color value of a pixel adjacent on the lower side to the pixel or a pixel located away at a predetermined distance from the pixel toward the lower side is equal to or greater than the threshold value, the evaluation point calculation module 122 extracts the pixel as an upper end edge pixel. Similarly, when a brightness value or a color value of each pixel is less than the threshold value, and a brightness value or a color value of a pixel adjacent on the upper side to the pixel or a pixel located away at a predetermined distance from the pixel toward the upper side is equal to or greater than the threshold value, the evaluation point calculation module 122 extracts the pixel as a lower end edge pixel.

The evaluation point calculation module 122 extracts straight lines that couple each of the extracted left end edge pixel, right end edge pixel, upper end edge pixel, and lower end edge pixel by using the Hough transform, the least squares method, etc., and detects a rectangle constituted of the extracted straight lines as a plate frame.

Next, the evaluation point calculation module 122 assigns a region number to each of the detected character regions (step S202). For example, the evaluation point calculation module 122 assigns region numbers in an ascending order from a character region having a centroid position located on the left end side in the horizontal direction (assigns region numbers of 1, 2, 3, and 4 in order from a character region located farthest on the left side) for each character region detected from a first input image being generated. On the other hand, the evaluation point calculation module 122 determines whether or not a character region detected from a second or subsequent input image being generated corresponds to any character region detected from an input image being generated in the past (whether or not two character regions partially overlap each other, for example). When a newly detected character region corresponds to a character region being detected in the past, the evaluation point calculation module 122, assigns, to the newly detected character region, a region number assigned to the corresponding character region being detected in the past. On the other hand, when a newly detected character region does not correspond to a character region being detected in the past, the evaluation point calculation module 122 assigns a new region number to each newly detected character region.

The evaluation point calculation module 122 stores each of the detected character regions in a character region table.

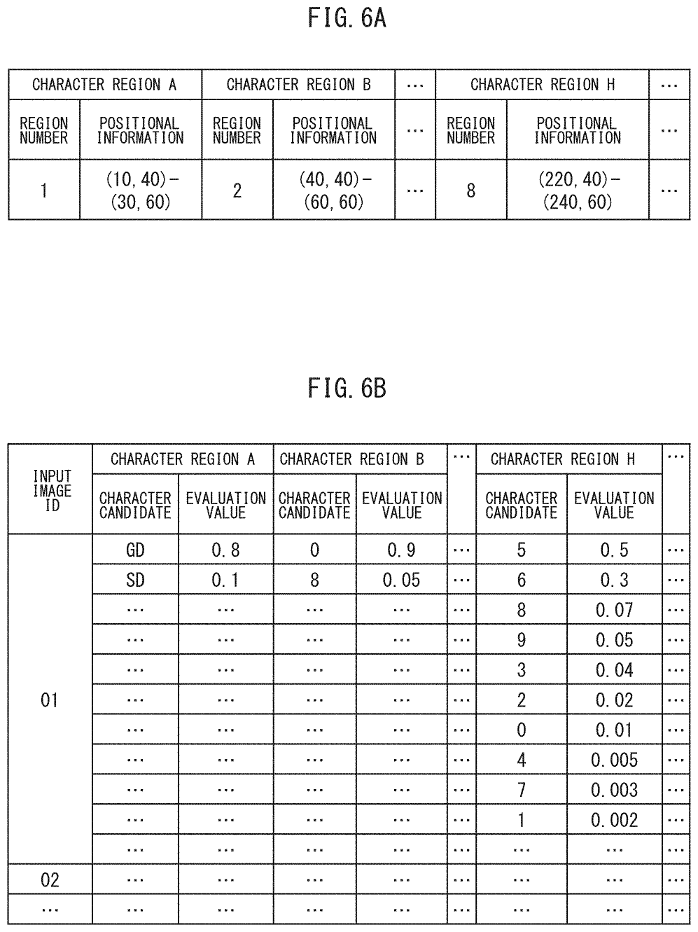

FIG. 6A is a diagram illustrating one example of a data structure of the character region table.

In the character region table, information such as a region number and positional information is stored in association with each character region. The region number is a region number assigned to each character region. The positional information is information indicating coordinates, etc., in an input image of each character region, and, for example, coordinates of an upper left end and coordinates of a lower right end are stored as the positional information.

Next, the evaluation point calculation module 122 specifies a plurality of character candidates for a character in each of the character regions for each of the detected character regions, and calculates an evaluation point for each of the plurality of specified character candidates (step S203). In other words, the evaluation point calculation module 122 calculates an evaluation point for each of the plurality of character candidates for each group of the character in the input image.

The evaluation point calculation module 122 specifies each character candidate, and calculates an evaluation point for each of the character candidates with the discriminator being previously learned in such a way as to output information indicating a plurality of character candidates for the character in the image and an evaluation point for each of the character candidates when an image in which a character is captured is input. Each of the evaluation points is a point indicating a probability, accuracy, precision, etc., that the character captured in the image is each of the character candidates, and is previously learned to be higher as the character captured in the image is more likely to be each of the character candidates. This discriminator is previously learned by using a plurality of images in which various characters are captured, by deep learning, etc., for example, and is previously stored in the storage device 110. The evaluation point calculation module 122 inputs an image including each of the character regions to the discriminator, and acquires information indicating a character candidate output from the discriminator and an evaluation point of each character candidate. Note that the evaluation point calculation module 122 may specify a character candidate captured in a character region and calculate an evaluation point of the character candidate by using a known OCR technique.

The evaluation point calculation module 122 stores, in a character candidate table, the plurality of character candidates specified for each of the character regions and the evaluation point of each of the character candidates in association with each other.

FIG. 6B is a diagram illustrating one example of a data structure of the character candidate table.

In the character candidate table, for each of input images, identification information (input image ID) about each of the input images, a plurality of character candidates specified for each character region included in each of the input images, and an evaluation point of each of the character candidates are stored in association with one another. When a character candidate is not specified for each character region, a blank is stored as a character candidate and an evaluation point.

Next, the evaluation point calculation module 122 determines whether or not one or more character candidates are specified from the input image (step S204).

When a character candidate cannot be specified from the input image, the evaluation point calculation module 122 shifts the processing to step S211. On the other hand, when one or more character candidates are specified from the input image, the evaluation point calculation module 122 determines whether or not processing of specifying a character candidate is performed on a predetermined number (10, for example) or more of input images (step S205).

When the processing of specifying a character candidate is not yet performed on the predetermined number or more of input images, the evaluation point calculation module 122 shifts the processing to step S212. When the processing of specifying a character candidate is performed on the predetermined number or more of input images, the evaluation point calculation module 122 shifts the processing to step S206. Processing in steps S206 to S210 are performed on each of the detected character regions.

When the processing of specifying a character candidate is performed on the predetermined number or more of input images, the character recognition module 123 calculates a degree of certainty of each specified character candidate (step S206). The degree of certainty indicates a degree of a likelihood that the character candidate is captured in each character region, and is calculated based on a plurality of evaluation points calculated for each input image being successively generated.

For example, the character recognition module 123 specifies, for each input image being successively generated, a character candidate having the greatest evaluation point from among a plurality of character candidates specified for each character region. Then, the character recognition module 123 calculates, as a degree of certainty of each of the character candidates, a proportion of the number of times each of the character candidates is specified as the character candidate having the greatest evaluation point to a predetermined number. Note that the character recognition module 123 may calculate, as a degree of certainty of each of the character candidates, an average value of all (or the latest predetermined number of) evaluation points being calculated for each of the character candidates.

Next, the character recognition module 123 determines whether or not a character candidate having a degree of certainty equal to or greater than a predetermined threshold value is present (step S207). The predetermined threshold value is set to 50%, for example.

For example, the character recognition module 123 specifies a mode of a character candidate having a maximum evaluation point among character candidates specified for the predetermined number of the input images. The character recognition module 123 specifies, as a mode, a character candidate being most frequently specified as the character candidate having the maximum evaluation point among the latest predetermined number of character candidates. The character recognition module 123 determines whether or not a character candidate having a degree of certainty equal to or greater than the predetermined threshold value is present, depending on whether or not a degree of certainty (proportion of the number of occurrences of the mode to a predetermined number) of the character candidate related to the mode is equal to or greater than the predetermined threshold value.

Alternatively, the character recognition module 123 specifies a character candidate having a maximum average value of evaluation points among character candidates specified for the predetermined number of the input images. The character recognition module 123 determines whether or not a character candidate having a degree of certainty equal to or greater than the predetermined threshold value is present, depending on whether or not a degree of certainty (average value of evaluation points) of the character candidate having the maximum average value of the evaluation points is equal to or greater than the predetermined threshold value.

When a character candidate having a degree of certainty equal to or greater than the predetermined threshold value is not present, the character recognition module 123 determines that each of the character candidates is not yet reliable, and shifts the processing to step S209. On the other hand, when a character candidate having a degree of certainty equal to or greater than the predetermined threshold value is present, the character recognition module 123 confirms (recognizes), as a character in the character region, a character candidate having the highest degree of certainty among the character candidates having the degree of certainty equal to or greater than the predetermined threshold value (step S208). In this way, the character recognition module 123 confirms a character only when a calculated degree of certainty is equal to or greater than the predetermined threshold value, and thus reliability of the recognized character can be further increased.

Next, the character recognition module 123 determines whether or not the processing on all the detected character regions is completed (step S209).

When a character region having the processing that is not yet completed is present, the character recognition module 123 returns the processing to step S206 and repeats the processing in steps S206 to S209. On the other hand, when the processing on all the detected character regions is completed, the character recognition module 123 determines whether or not characters in all the character regions are confirmed (step S210).

When the characters in all the character regions are confirmed, the character recognition module 123 recognizes a character string acquired by combining the characters confirmed for all the respective character regions as characters in the input image (step S211), and terminates the series of steps.

In this way, the character ecognition module 123 specifies and compiles, for each group of character regions, a character captured in each input image being successively generated, and recognizes the character, based on a compiled result. The character recognition module 123 also specifies a character in another character region and uses the character for compilation for an input image in which a character in a specific character region cannot be specified, and thus a character can be accurately recognized by using a fewer input images. A user does not need to continue perform capturing until an input image in which all characters are recognizable is generated, and thus the image processing apparatus 100 can reduce the workload for the user. Note that the character recognition module 123 may collectively specify and compile a character captured in each input image being successively generated for all character regions, and recognize the character, based on a compiled result,

On the other hand, when the characters in all the character regions are not yet confirmed, the character recognition module 123 determines whether or not the predetermined condition is satisfied since the processing of calculating an evaluation point starts (step S212).

The predetermined condition is a condition where a predetermined period of time (one second, for example) has elapsed since the processing of calculating an evaluation point starts, for example. In this case, the character recognition module 123 starts measuring a time when a character candidate is first detected in step S204, and determines that the predetermined condition is satisfied when the predetermined period of time has elapsed.

Further, the predetermined condition may be a condition where character recognition processing is performed from a predetermined number (30, for example) of input images. In this case, each time the character recognition module 123 performs the determination processing on one input image, the character recognition module 123 increments the number of processing, and determines that the predetermined condition is satisfied when the number of processing becomes the predetermined number or more.

Further, the predetermined condition may be a condition where a difference (interframe difference value) in each pixel value between input images being successively generated (or character regions in an input image) becomes equal to or less than an upper limit value, In this case, the character recognition module 123 calculates an absolute value of a difference between pixels corresponding to each other (on the same coordinates) for all pixels (or pixels in a character region) of a current input image and a previously generated input image. When a sum total of the absolute values of the differences calculated for the pixels becomes equal to or less than the upper limit value, the character recognition module 123 determines that the predetermined condition is satisfied. Alternatively, the character recognition module 123 calculates a sum total of absolute values of the differences for each pair of consecutive input images, and determines that the predetermined condition is satisfied when a total of the sum totals calculated for the latest predetermined number of (30, for example) pairs becomes equal to or less than the upper limit value.

Further, the predetermined condition may be a condition where the newest input image (or a character region in the newest input image) is clear. An image being clear means that a character included in the image is recognizable, and means that blurring or a shine is not included in the image. In contrast, the image being unclear means that a character included in the image is not recognizable, and means that blurring or a shine is included in the image. The blurring refers to a region in which a difference in brightness value between pixels in the image is reduced due to defocusing of the imaging device 104, or a region in which the same object is captured in a plurality of pixels in the image due to camera shake of a user, and a difference in brightness value between pixels in the image is reduced. The shine refers to a region in which a brightness value of a pixel in a predetermined region in the image becomes saturated at a fixed value (a whiteout occurs) due to an influence of disturbance light, etc.

The character recognition module 123 determines whether or not blurring is included in the image by a discriminator being previously learned in such a way as to output a degree of the blurring indicating a degree of the blurring included in an input image when the image is input. This discriminator is previously learned by using an image in which a character is captured and blurring is not included, by deep learning, etc., for example, and is previously stored in the storage device 110. Note that this discriminator may be previously learned by further using an image in which a character is captured and blurring is included. The character recognition module 123 inputs an image to the discriminator, and determines whether or not blurring is included in the image, depending on whether or not a degree of the blurring output from the discriminator is equal to or greater than a threshold value.

Alternatively, the character recognition module 123 may determine whether or not blurring is included in an image, based on edge strength of a brightness value of each pixel included in the image. The character recognition module 123 calculates an absolute value of a difference in brightness value between pixels on both sides in the horizontal or vertical direction of a pixel in the image or between a plurality of pixels located away at a predetermined distance from the pixel, as edge strength of the pixel. The character recognition module 123 determines whether or not the blurring is included in the image, depending on whether or not an average value of the edge strength calculated for each pixel in the image is equal to or less than a threshold value.

Alternatively, the character recognition module 123 may determine whether or not blurring is included in an image, based on distribution of a brightness value of each pixel included in the image. The character recognition module 123 generates a histogram of a brightness value of each pixel in the image, detects a maximal value in each of a range of a brightness value indicating a numerical value (white) and a range of a brightness value indicating a background (black), and calculates an average value of half-value widths of each of the maximal values. The character recognition module 123 determines whether or not the blurring is included in the image, depending on whether or not the average value of the half-value widths of each of the calculated maximal values is equal to or less than a threshold value,

Further, the character recognition module 123 determines whether or not a shine is included in the image by a discriminator being previously learned in such a way as to output a degree of the shine indicating a degree of the shine included in an input image when the image is input. This discriminator is previously learned by using an image in which a character is captured and a shine is not included, by deep learning, etc., for example, and is previously stored in the storage device 110. Note that this discriminator may be previously learned by further using an image in which a character is captured and a shine is included. The character recognition module 123 inputs an image to the discriminator, and determines whether or not a shine is included in the image, depending on whether or not a degree of the shine output from the discriminator is equal to or greater than a threshold value.

Alternatively, the character recognition module 123 may determine whether or not a shine is included in an image, based on a brightness value of each pixel included in the image. The character recognition module 123 calculates the number of pixels having a brightness value equal to or greater than a threshold value (white) among pixels in the image, and determines whether or not the shine is included in the image, depending on whether or not the calculated number is equal to or greater than another threshold value.

Alternatively, the character recognition module 123 may determine whether or not a shine is included in an image, based on distribution of a brightness value of each pixel included in the image. The character recognition module 123 generates a histogram of the brightness value of each pixel in the image, and determines whether or not the shine is included in the image, depending on whether or not the number of pixels distributed in a region having a value equal to or greater than a threshold value is equal to or greater than another threshold value.

Note that each of the threshold values and each of the ranges described above are previously set according to result of previous experiment.

When the predetermined condition is satisfied, the character recognition module 123 terminates the processing of calculating an evaluation point even when a character candidate having a degree of certainty equal to or greater than the predetermined threshold value is not present, and terminates the series of steps. On the other hand, when the predetermined condition is not satisfied, the character recognition module 123 determines whether or not termination of the processing of calculating an evaluation point is instructed by the user with the input device 102 (step S213).

When the termination of the processing of calculating an evaluation point is instructed by the user, the character recognition module 123 terminates the processing of calculating an evaluation point even when a character candidate having a degree of certainty equal to or greater than the predetermined threshold value is not present, and terminates the series of steps. On the other hand, when the termination of the processing of calculating an evaluation point is not instructed by the user, the character recognition module 123 returns the processing to step S201 and repeats the processing in steps S201 to S213 on an input image being generated next.

Note that, in step S205, the character recognition module 123 may perform the processing in and after step S206 as long as the number of input images on which the processing of specifying a character candidate is performed is equal to or greater than the number that allows a character to be confirmed even when the number of input images is not equal to or greater than the predetermined number. For example, in a case where the predetermined number is 10 and the predetermined threshold value is 50%, when the same character is specified for all input images on which the processing of specifying a character candidate is performed at a point in time at which the number of the input images is six, the character is a mode, and a proportion of the number of occurrences of the mode is equal to or greater than 60%. In such a case, the character recognition module 123 may confirm a recognized numerical value even when the number of the input images on which the processing of specifying a character candidate is performed is not equal to or greater than the predetermined number. In this way, the character recognition module 123 can shorten processing time required for the determination processing.

Further, when a character in a character region to be processed is already confirmed, the character recognition module 123 may omit the processing in steps S206 to S208 for the character region. In this way, the character recognition module 123 can shorten processing time required for the determination processing.

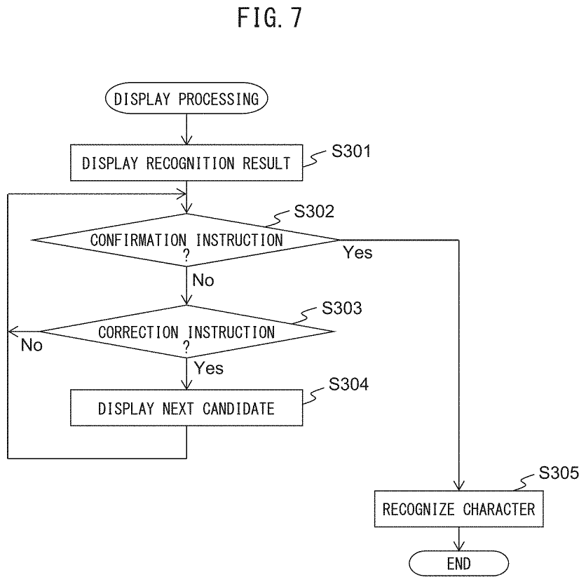

FIG. 7 is a flowchart illustrating an example of an operation of the display processing. A flow of the operation illustrated in FIG. 7 is performed in step S103 in the flowchart illustrated in FIG. 3.

First, the character recognition module 123 displays, on the display device 103, a plurality of character candidates specified for each group of each character region in the determination processing in such a way as to be switchable (step S301). The character recognition module 123 first extracts a character candidate having the highest evaluation point for each character region with reference to the character candidate table, and aligns and displays each of the extracted character candidates in order of region number. For example, the character recognition module 123 extracts a character candidate having the highest average value of all (or the latest predetermined number of) evaluation points. Note that the character recognition module 123 may extract a character candidate having the highest evaluation point calculated from the newest input image.

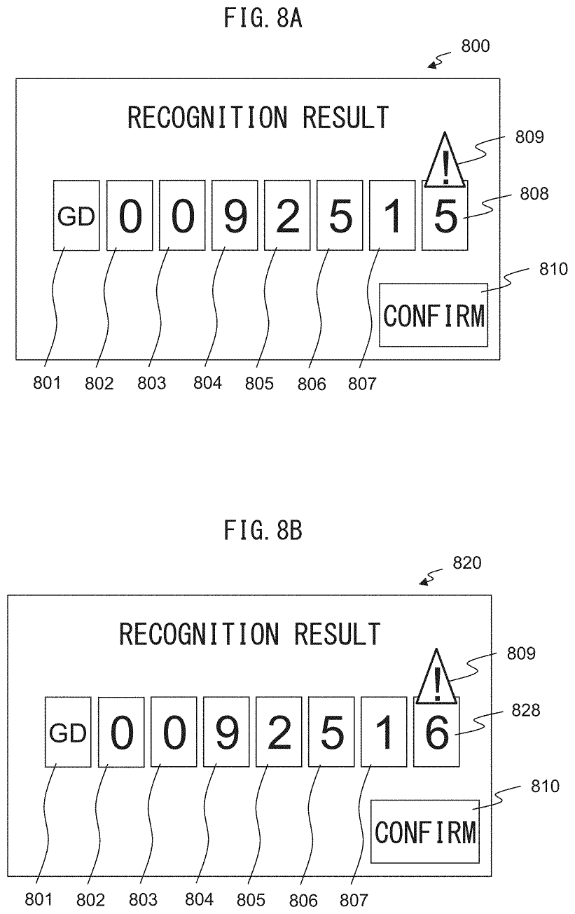

FIG. 8A is a diagram illustrating one example of a display screen 800 to be displayed on the display device 103.

As illustrated in FIG. 8A, in the display screen 800, each of character candidates 801 to 808 having the highest evaluation point calculated in each character region is aligned and displayed in order from a character region having a centroid position located on the left end side in the horizontal direction in an input image. Each of the character candidates 801 to 808 displayed on the display screen 800 is displayed in such a way as to be switchable by a user using the input device 102. The display screen 800 displays a symbol 809 for identifying a character candidate having a degree of certainty less than a predetermined threshold value among the character candidates 801 to 808. Note that the display for identifying the character candidate having the degree of certainty less than the predetermined threshold value is not limited to the symbol 809, and may be any warning image. Further, instead of or in addition to displaying the symbol 809, the character recognition module 123 may differentiate a display color, a display size, etc., of the character candidate having the degree of certainty less than the predetermined threshold value among the character candidates 801 to 808 from a display color, a display size, etc., of a character candidate having a degree of certainty equal to or greater than the predetermined threshold value.

In this way, the character recognition module 123 displays, on the display device 103, a group of character regions in which the character candidate having the degree of certainty equal to or greater than the predetermined threshold value is present and a group of character regions in which the character candidate having the degree of certainty equal to or greater than the predetermined threshold value is not present in such a way as to be identifiable. In this way, the user can easily identify a character candidate having a low degree of certainty, and is more likely to notice that a character candidate different from an actual character is displayed.

Further, the display screen 800 displays a confirmation button 810 for confirming a displayed character candidate as a character in the input image.

Next, the character recognition module 123 determines whether or not the confirmation button 810 is pressed by the user with the input device 102, and a confirmation instruction is input (step S302).

When the confirmation instruction is not input, the character recognition module 123 determines whether or not each of the character candidates 801 to 808 is pressed by the user with the input device 102, and a correction instruction is input (step S303).

When the correction instruction is not input, the character recognition module 123 returns the processing to step 5302, and determines again whether or not the confirmation instruction is input. On the other hand, when the correction instruction is input, the character recognition module 123 switches the pressed character candidate to a next character candidate (step S304), and returns the processing to step 5302. The character recognition module 123 extracts a character candidate having a highest evaluation point among character candidates having lower evaluation point than the currently displayed character candidate for the corresponding character region with reference to the character candidate table, and changes the currently displayed character candidate to the extracted character candidate. Note that, when a character candidate having the lowest evaluation point is displayed, the character recognition module 123 extracts a character candidate having the highest evaluation point.

FIG. 8B is a diagram illustrating one example of a display screen 820 in which the character candidate is switched.

In the example illustrated in FIG. 8B, in the display screen 820, a character candidate 828 having a highest evaluation point among character candidates having lower evaluation point than the character candidate 808 is switched from the character candidate 808 and is displayed by pressing the character candidate 808 displayed on the display screen 800 by the user.

Note that, in the display screens 800 and 820, a character candidate having a highest evaluation point among character candidates having lower evaluation point than each character candidate being currently displayed or a predetermined number of (two, for example) character candidates in descending order of evaluation point among character candidates having lower evaluation point than each character candidate being currently displayed may be displayed in association with each character candidate being currently displayed. In this way, the user can previously recognize a character candidate to be displayed next when each character candidate is designated, and thus the user can more easily switch to a correct character candidate.

In this way, the character recognition module 123 displays, on the display device 103, a plurality of character candidates in order based on evaluation points. By displaying character candidates in order based on the evaluation points, a character candidate being displayed first is highly likely to be correct, and correction of a character by the user is highly likely to be unnecessary. As a result, time required for the recognition processing can be shortened. Further, the user can switch a false character candidate to a character candidate being highly likely to be correct next, simply by pressing (designating) the false character candidate, and a character candidate can be switched easily in a short time. In this way, the image processing apparatus 100 can reduce the workload for the user.

On the other hand, when the confirmation instruction is input in step 5302, the character recognition module 123 confirms (recognizes) a combination of character candidates currently displayed on the display screen 80( )as characters in the input image (step S305), and terminates the series of steps, in this way, when one of character candidates displayed on the display device 103 is designated by the user with the input device 102, the character recognition module 123 sets the designated character candidate as a character in the input image. Particularly, when each of character candidates displayed on the display device 103 is designated by the user with the input device 102, the character recognition module 123 sets characters acquired by combining the designated character candidates as characters in the input image,

Note that the character recognition module 123 may transmitthe recognized character to the server device via the communication device 101.

Further, the character recognition module 123 may display, on the display screen 800, a confirmed character for a character region in which the character in the character region is confirmed in step S208, and may not receive the change instruction by the user.

Further, the image processing apparatus 100 may perform the determination processing and the display processing in non-synchronization with timing at which the image processing apparatus 104 generates an input image instead of performing the determination processing and the display processing in real time according to the timing at which the image processing apparatus 104 generates the input image.

As described above in detail, the image processing apparatus 100 can further shorten time required for the recognition processing by operating according to the flowcharts illustrated in FIGS. 3, 4, and 7.

For example, when the image processing apparatus 100 captures a hand-held meter, etc., the user holds the meter with one of hands while holding the image processing apparatus 100 with the other hand, and thus an input image may become blur due to a shaky arm. Further, when a meter installed at a high place is captured, the user stretches an arm and holds the image processing apparatus 100, and thus an input image may become blur due to a shaky arm. Further, when a meter is captured in rainy weather, a disturbance (noise) may occur in an input image. In these cases, the input image becomes unclear, and a great deal of time is required until a correct character (numerical value) is read. When the predetermined condition is satisfied, the image processing apparatus 100 terminates the processing of calculating an evaluation point even when a character candidate having a degree of certainty equal to or greater than the predetermined threshold value is not present. Then, the image processing apparatus 100 displays each of character candidates in order based on the evaluation points. When each of the character candidates is designated by the user, the image processing apparatus 100 sets the designated character candidate as a character in the input image, In this way, the image processing apparatus 100 can shorten time required for the recognition processing.

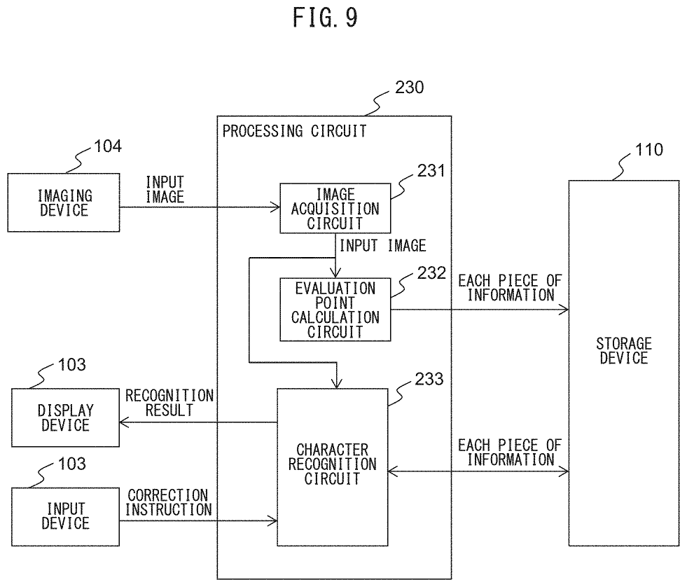

FIG. 9 is a block diagram illustrating a schematic configuration of a processing circuit 230 in an image processing apparatus according to another embodiment.

The processing circuit 230 is used instead of the processing circuit 130 of the image processing apparatus 100, and performs whole processing instead of the CPU 120. The processing circuit 230 includes an image acquisition circuit 231, an evaluation point calculation circuit 232, a character recognition circuit 233, etc.

The image acquisition circuit 231 is one example of an image acquisition module, and has a function similar to that of the image acquisition module 121. The image acquisition circuit 231 successively acquires an input image from an imaging device 104, and transmits the input image to the evaluation point calculation circuit 232 and the character recognition circuit 233.

The evaluation point calculation circuit 232 is one example of an evaluation point calculation module, and has a function similar to that of the evaluation point calculation module 122. The evaluation point calculation circuit 232 specifies a plurality of character candidates for a character in each input image, calculates an evaluation point for each character candidate, and stores the evaluation point in a storage device 110.

The character recognition circuit 233 is one example of a character recognition module, and has a function similar to that of the character recognition module 123. The character recognition circuit 233 calculates a degree of certainty for each character candidate, and, when a character candidate having a degree of certainty equal to or greater than a predetermined threshold value is present, the character recognition circuit 233 recognizes the character candidate as a character in the input image. Further, when a predetermined condition is satisfied since processing of calculating an evaluation point starts, the character recognition circuit 233 terminates the processing of calculating an evaluation point even when a character candidate having a degree of certainty equal to or greater than the predetermined threshold value is not present, and displays, on a display device 103, a plurality of character candidates in order based on the evaluation points. Further, when the character recognition circuit 233 receives, from an input device 102, a correction instruction of a character candidate displayed on the display device 103, the character recognition circuit 233 sets a designated character candidate as a character in the input image.

As described above in detail, the image processing apparatus 100 can also further shorten time required for the recognition processing when the processing circuit 230 is used

Although the suitable embodiments of the present invention have been described, the present invention is not limited to the embodiments. For example, each discriminator used in the determination processing may not be stored in the storage device 110, and may be stored in an external device such as the server device. In this case, the evaluation point calculation module 122 and the character recognition module 123 transmit each image to the server device via the communication device 101, and receive and acquire an identification result to be output from each discriminator from the server device.

Further, the image processing apparatus 100 is not limited to a portable information processing device, and may be a stationary camera, etc., installed in such a way as to be able to capture a meter, etc., for example.

### REFERENCE SIGNS LIST

100 Image processing apparatus
102 Input device
103 Display device
104 Imaging device
122 Evaluation point calculation module
123 Character recognition module

1. An image processing apparatus, comprising:
an operation device;
a display device;
an imaging device to successively generate an input image; and
a processor to
calculate, for each of the successively generated input images, an evaluation point for each of a plurality of character candidates for a character in each input image;
recognize, when a character candidate whose degree of certainty based on the plurality of evaluation points calculated for each of the successively generated input images is equal to or greater than a threshold value is present, the character candidate as a character in the input image,
terminate processing of calculating the evaluation point, even when a character candidate having the degree of certainty equal to or greater than the threshold value is not present, in a case where a predetermined condition is satisfied since processing of calculating the evaluation point starts,
display, on the display device, the plurality of character candidates in order based on the evaluation point, and
set, when one of character candidates displayed on the display device is designated by a user with the operation device, the designated character candidate as a character in the input image.

2. The image processing apparatus according to claim 1, wherein the predetermined condition is a condition where a predetermined period of time has elapsed or character recognition processing is performed from a predetermined number of input images.

3. The image processing apparatus according to claim 1, wherein the processor specifies a character candidate having a maximum evaluation point among the plurality of character candidates for each of the successively generated input images, specifies a mode among character candidates specified for a predetermined number of input images, and calculates a proportion of the number of occurrences of the mode to the predetermined number as the degree of certainty of a character candidate related to the mode.

4. The image processing apparatus according to claim 1, wherein
the processor calculates an evaluation point for each of a plurality of character candidates for each group of characters in each input image, and wherein
the processor
displays, on the display device, the plurality of character candidates for each group in such a way as to be switchable, and
sets, when each of character candidates displayed on the display device is designated by a user with the operation device, characters acquired by combining the designated character candidates as characters in the input image.

5. The image processing apparatus according to claim 4, wherein the processor displays, on the display device, a group in which a character candidate having the degree of certainty equal to or greater than the threshold value is present and a group in which a character candidate having the degree of certainty equal to or greater than the threshold value is not present in such a way as to be identifiable.

6. The image processing apparatus according to claim 1, wherein
the processor
terminates processing of calculating the evaluation point, even when a character candidate having the degree of certainty equal to or greater than the threshold value is not present, in a case where termination of processing of calculating the evaluation point is instructed by a user with the operation device,
displays the plurality of character candidates on the display device in such a way as to be switchable, and
sets, when a character candidate displayed on the display device is designated by a user with the operation device, the designated character candidate as a character in the input image.

7. A control method of an image processing apparatus including an operation device, a display device, an imaging device to successively generate an input image, the method comprising:
calculating, for each of the successively generated input images, an evaluation point for each of a plurality of character candidates for a character in each input image;
recognizing, when a character candidate whose degree of certainty based on the plurality of evaluation points calculated for each of the successively generated input images is equal to or greater than a threshold value is present, the character candidate as a character in the input image,
terminating processing of calculating the evaluation point, even when a character candidate having the degree of certainty equal to or greater than the threshold value is not present, in a case where a predetermined condition is satisfied since processing of calculating the evaluation point starts;
displaying the plurality of character candidates, on the display device, in order based on the evaluation point; and
setting, when one of character candidates displayed on the display device is designated by a user with the operation device, the designated character candidate is set as a character in the input image,

8. A computer-readable, non-transitory medium storing a computer program, wherein the computer program causes an image processing apparatus including an operation device, a display device, an imaging device to successively generate an input image, to to execute a process, the process comprising:
calculating, for each of the successively generated input images, an evaluation point for each of a plurality of character candidates for a character in each input image; and
recognizing, when a character candidate whose degree of certainty based on the plurality of evaluation points calculated for each of the successively generated input images is equal to or greater than a threshold value is present, the character candidate as a character in the input image;
terminating processing of calculating the evaluation point, even when a character candidate having the degree of certainty equal to or greater than the threshold value is not present, in a case where a predetermined condition is satisfied since processing of calculating the evaluation point starts;
displaying the plurality of character candidates, on the display device, in order based on the evaluation point; and
setting, when one of character candidates displayed on the display device is designated by a user with the operation device, the designated character candidate is set as a character in the input image,
